(19) United States
(12) Patent Application Publication
(10) Pub. No.: US 2020/0319519 A1
(43) Pub. Date: Oct. 8, 2020

(54) LIQUID CRYSTAL DISPLAY PANEL

(71) Applicant: Wuhan China Star Optoelectronics Technology Co., Ltd., Vuhan (CN)

(72) Inventors: Yuehua Yang, Wuhan (CN); Mang Zhao, Wuhan (CN)

(21) Appl. No.: 16/308,815

(22) PCT Filed: Sep. 27, 2018
(86) PCT No.: PCT/CN2018/108119

§ 371 Date: Dec. 10, 2018

(30) Foreign Application Priority Data
Jul. 24, 2018 (CN) 201810822295.9

(51) Int. Cl. G02F 1/1362

(52) U.S. Cl. CPC G02F 1/136286; G02F 2201/56

(57) ABSTRACT

Provided is a liquid crystal display panel adopting a notch design. The capacitance compensation module corresponding to the notch of the substrate and located in the peripheral area is disposed on the substrate. The capacitance compensation module includes semiconductor blocks and compensation traces. Each row of semiconductor blocks is correspondingly located below one first sub-scan line. Each compensation trace is correspondingly located above one column of semiconductor blocks and intersects with the first sub-scan lines. Each first sub-scan line is connected to one row of corresponding semiconductor blocks thereto via through holes. In any two first sub-scan lines, a capacitance between the first sub-scan line away from the notch, the corresponding semiconductor block and the compensation trace below the first sub-scan line is smaller than a capacitance between the first sub-scan line close to the notch, the corresponding semiconductor block and the compensation trace below the first sub-scan line.

### FIELD OF THE INVENTION

The present invention relates to a display technology field, and more particularly to a liquid crystal display panel.

### BACKGROUND OF THE INVENTION

In the display skill field, the Liquid Crystal Display (LCD) and other panel displays have been gradually replaced the Cathode Ray Tube (CRT) displays. A liquid crystal display possesses advantages of being ultra thin, power saved and radiation free and has been widely utilized.

Most of the liquid crystal displays on the present market are back light type liquid crystal display devices, which comprise a liquid crystal display panel and a back light module. Generally, the liquid crystal display panel comprises a Color Filter (CF) substrate, a Thin Film Transistor (TFT) substrate, Liquid Crystal (LC) sandwiched between the CF substrate and the TFT substrate and sealant. The working principle of the liquid crystal display panel is to locate liquid crystal molecules between two parallel glass substrates, and a plurality of vertical and horizontal tiny electrical wires are between the two glass substrates. The light of back light module is reflected to generate images by applying driving voltages to control whether the liquid crystal molecules to be changed directions.

With the continuous development of display technology, a full screen has become the design trend of current smart phones. For realizing a full screen, a display panel with an indentation (notch) design is provided according to the prior art. The so-called notch design display panel refers to a hollowed out area at one end of the display panel for placing electronic components, such as a headphone and a camera, and the two sides of hollowed out area can used for display, thereby increasing the overall screen occupation ratio of the display panel.

Please refer to FIG. 1, which is a structural view diagram of a liquid crystal display panel at a notch according to the prior art. The liquid crystal display panel comprises a substrate 100 and a plurality of scan lines 200 sequentially arranged on the substrate 100. One end of the substrate 100 is provided with a notch 150, of which a concave direction is consistent with an arrangement direction of the plurality of scan lines 200. The substrate 100 comprises an active display area 110 and a peripheral area 120 outside the active display area 110. The plurality of scan lines 200 comprises a plurality of first scan lines 210 located in the active display area 110 and a plurality of second scan lines 220 between an area where the plurality of first scan lines 210 are located and an edge of the end of the substrate 100 having the notch 150. Each of the second scan lines 220 comprises a first sub-scan line 2210 and two second sub-scan lines 2220 respectively connected to two ends of the first sub-scan line 2210. The first sub-scan line 2210 of each second scan line 220 corresponds to the notch 150 and is located in the peripheral area 120, and the two second sub-scan lines 2220 of each second scan line 220 are respectively located on two sides of the notch 150 and are located in the active display area 110. The liquid crystal display panel adopts a notch design. The RC loading of the plurality of second scan lines 220 is smaller than the RC loading of the plurality of first scan lines 210, which causes a difference in brightness between the areas on two sides of the notch 150 and other areas of the liquid crystal display panel, and a split-screen phenomenon occurs at the boundary, which affects the display effect. For implementing capacitive resistance compensation on the second scan lines 220, referring to FIG. 1 in conjunction with FIG. 2 and FIG. 3, the liquid crystal display panel further includes a capacitance compensation module 300 disposed on the substrate 100. The capacitance compensation module 300 corresponds to the notch 150 and is located in the peripheral area 120. The capacitance compensation module 300 comprises a plurality of semiconductor blocks 310 disposed in an array and between the substrate 100 and the plurality of first sub-scan lines 2210, and insulated from the plurality of first sub-scan lines 2210, and a plurality of compensation traces 320 between the plurality of semiconductor blocks 310 and the plurality of first sub-scan lines 2210, and insulated from the plurality of semiconductor blocks 310 and the plurality of first sub-scan lines 2210. Each row of semiconductor blocks 310 is correspondingly located below one first sub-scan line 2210. Each compensation trace 320 is correspondingly located above a column of semiconductor blocks 310 and intersects with the plurality of first sub-scan lines 2210. Each first sub-scan line 2210 is connected to a row of semiconductor blocks 310 corresponding thereto via through holes 330. The plurality of compensation traces 320 are connected to a preset reference potential. A capacitance between the first sub-scan line 2210 of the second scan line 220, the corresponding row of semiconductor blocks and the compensation trace is used to implement capacitance compensation to the second scan line 220. In the prior art, the same capacitance is compensated for each second scan line 220, that is, the widths of the same compensation trace 320 are the same everywhere, and the width of the compensation trace 320 is calculated by simulation. This design can only reduce the display difference of the liquid crystal display panel at the boundary between the areas on two sides of the notch 150 and other areas. However, the width of the notch 150 is gradually decreased in the direction to the center of the substrate 100, that is, the RC loadings between the second scan lines 210 at different positions are also different, resulting in that the brightness of the vertical direction of the liquid crystal display panel in the areas on two sides of the notch 150 is uneven, which affects the display effect.

### SUMMARY OF THE INVENTION

An objective of the present invention is to provide a liquid crystal display panel, which can reduce a difference in RC loadings of scan lines to improve display quality.

For realizing the aforesaid objective, the present invention provides a liquid crystal display panel, comprising a substrate, a plurality of scan lines sequentially arranged on the substrate and a capacitance compensation module disposed on the substrate;

wherein one end of the substrate is provided with a notch, of which a concave direction is consistent with an arrangement direction of the plurality of scan lines; the substrate comprises an active display area and a peripheral area outside the active display area; the plurality of scan lines comprises a plurality of first scan lines located in the active display area and a plurality of second scan lines between an area where the plurality of first scan lines are located and an edge of the end of the substrate having the notch; each of the second scan lines comprises a first sub-scan line and two second sub-scan lines respectively connected to two ends of the first sub-scan line; the first sub-scan line of each second scan line corresponds to the notch and is located in the peripheral area, and the two second sub-scan lines of each second scan line are respectively located on two sides of the notch and are located in the active display area; the capacitance compensation module corresponds to the notch and is located in the peripheral area; the capacitance compensation module comprises a plurality of semiconductor blocks disposed in an array and between the substrate and the plurality of first sub-scan lines, and insulated from the plurality of first sub-scan lines, and a plurality of compensation traces between the plurality of semiconductor blocks and the plurality of first sub-scan lines, and insulated from the plurality of semiconductor blocks and the plurality of first sub-scan lines; each row of semiconductor blocks is correspondingly located below one first sub-scan line; each compensation trace is correspondingly located above a column of semiconductor blocks and intersects with the plurality of first sub-scan lines; each first sub-scan line is connected to a row of semiconductor blocks corresponding thereto via through holes; the plurality of compensation traces are connected to a preset reference potential; in any two first sub-scan lines, a capacitance between the first sub-scan line away from the notch, the corresponding semiconductor block and the compensation trace below the first sub-scan line is smaller than a capacitance between the first sub-scan line close to the notch, the corresponding semiconductor block and the compensation trace below the first sub-scan line.

In any two first sub-scan lines, a width of an overlapped area between the first sub-scan line away from the notch, the corresponding semiconductor block and the compensation trace below the first sub-scan line is smaller than a width of an overlapped area between the first sub-scan line close to the notch, the corresponding semiconductor block and the compensation trace below the first sub-scan line.

Each of the compensation traces comprises four trapezoidal portions connected in sequence; adjacent two trapezoidal portions are connected to each other by respective bottom edges, and lengths of the bottom edges of the adjacent two trapezoidal portions are equal.

Each compensation trace has a trapezoidal shape.

The plurality of semiconductor blocks are the same in size and rectangular in shape; the plurality of compensation traces are the same in size; portions of the plurality of first sub-scan lines located above an area of the capacitance compensation module are parallel to each other and have a same width; portions of any two adjacent first sub-scan lines located above the area of the capacitance compensation module have a same interval; a center line of the semiconductor blocks of each row parallel to an arrangement direction is coincident with a center line of portions of the corresponding first sub-scan lines located above the area of the capacitance compensation module; a size of the semiconductor block in a row direction of the plurality of semiconductor blocks is greater than a width of the compensation trace.

The plurality of compensation traces are perpendicular to the portions of the plurality of first sub-scan lines located above the area of the capacitance compensation module.

The liquid crystal display panel further comprises a plurality of rows of sub-pixels disposed on the substrate and correspondingly connected to the plurality of scan lines; wherein the plurality of rows of sub-pixels are located in the active display area; and the plurality of sub-pixels corresponding to the second scan lines are respectively connected to the two second sub-scan lines of the second scan line, and are respectively located at two sides of the notch.

The preset reference potential is a constant voltage low potential or a common potential.

The plurality of second sub-scan lines, the plurality of first scan line and the plurality of compensation traces are located in the same layer.

A distance between two side walls of the notch gradually decreases in a direction close to the center of the substrate.

The benefits of the present invention are: the liquid crystal display panel of the invention adopts a notch design. The capacitance compensation module corresponding to the notch of the substrate and located in the peripheral area is disposed on the substrate. The capacitance compensation module includes the plurality of semiconductor blocks and the plurality of compensation traces. Each row of semiconductor blocks is correspondingly located below one first sub-scan line. Each compensation trace is correspondingly located above one column of semiconductor blocks and intersects with the plurality of first sub-scan lines. Each first sub-scan line is connected to one row of semiconductor blocks corresponding thereto via through holes. In any two first sub-scan lines, a capacitance between the first sub-scan line away from the notch, the corresponding semiconductor block and the compensation trace below the first sub-scan line is smaller than a capacitance between the first sub-scan line close to the notch, the corresponding semiconductor block and the compensation trace below the first sub-scan line. Thus, the difference in RC loadings among the plurality of scan lines is compensated to improve the display effect.

### BRIEF DESCRIPTION OF THE DRAWINGS

In order to better understand the characteristics and technical aspect of the invention, please refer to the following detailed description and accompanying drawings of the present invention. However, the drawings are provided for reference only and are not intended to be limiting of the invention.

In drawings,

FIG. 1 is a structural view diagram of a liquid crystal display panel at a notch according to the prior art;

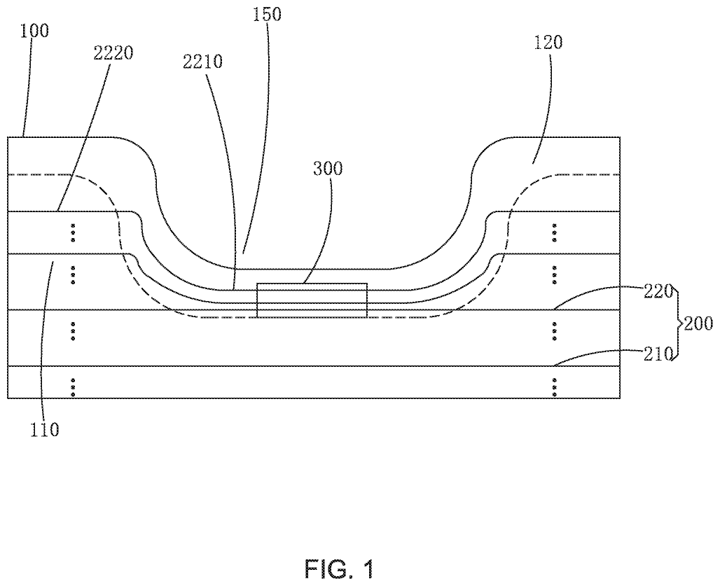

FIG. 2 is a partially enlarged view diagram of first sub-scan lines and compensation traces of the liquid crystal display panel shown in FIG. 1 at a capacitance compensation module;

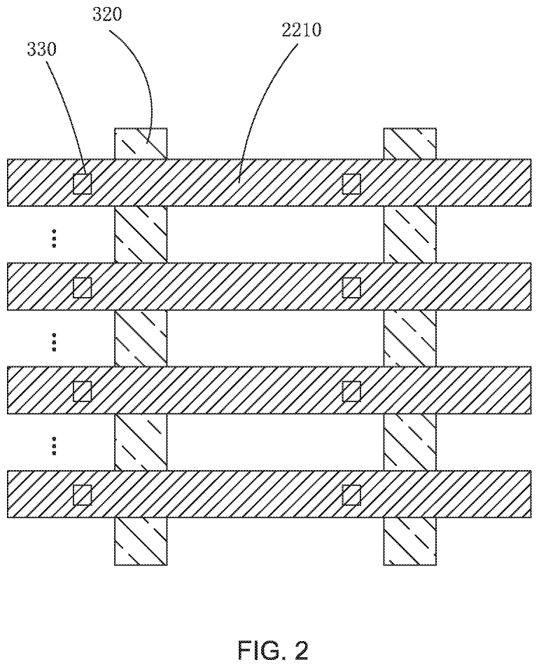

FIG. 3 is a partially enlarged view diagram of semiconductor blocks and the compensation traces of the liquid crystal display panel of FIG. 1 at the capacitance compensation module;

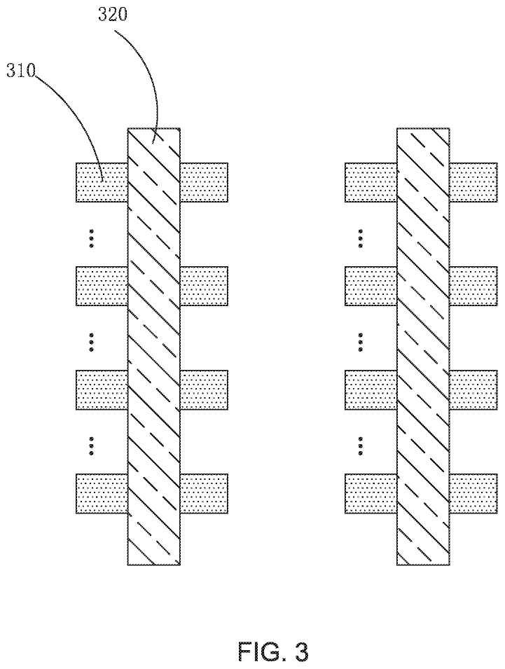

FIG. 4 is a structural view diagram of a liquid crystal display panel at a notch according to the present invention;

FIG. 5 is a partially enlarged view diagram of first sub-scan lines and compensation traces of the liquid crystal display panel at a capacitance compensation module according to the first embodiment of the present invention;

FIG. 6 is a partially enlarged view diagram of semiconductor blocks and compensation traces of the liquid crystal display panel at the capacitance compensation module according to the first embodiment of the present invention;

FIG. 7 is a structural diagram of a simulation system for acquiring a size of the compensation trace in the liquid crystal display panel according to the first embodiment of the present invention;

FIG. 8 is a partially enlarged view diagram of first sub-scan lines and compensation traces of the liquid crystal display panel at a capacitance compensation module according to the second embodiment of the present invention;

FIG. 9 is a partially enlarged view diagram of semiconductor blocks and compensation traces of the liquid crystal display panel at the capacitance compensation module according to the second embodiment of the present invention;

FIG. 10 is a structural diagram of a simulation system for acquiring a size of the compensation trace in the liquid crystal display panel according to the second embodiment of the present invention.

### DETAILED DESCRIPTION OF PREFERRED EMBODIMENTS

For better explaining the technical solution and the effect of the present invention, the present invention will be further described in detail with the accompanying drawings and the specific embodiments.

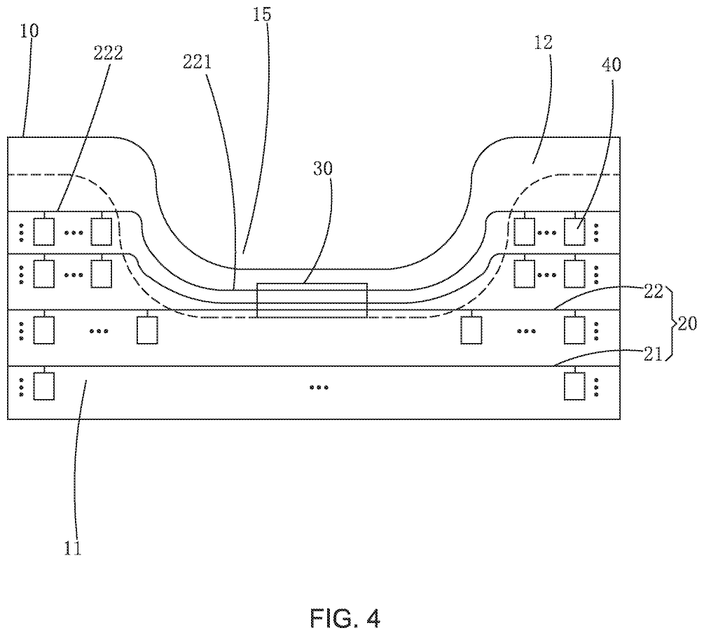

Please refer to FIGS. 4 to 6, the first embodiment of the liquid crystal display panel of the present invention includes a substrate 10, a plurality of scan lines 20 sequentially arranged on the substrate 10, a capacitance compensation module 30 disposed on the substrate 10 and a plurality of rows of sub-pixels 40 disposed on the substrate 10 and correspondingly connected to the plurality of scan lines 20.

One end of the substrate 10 is provided with a notch 15, of which a concave direction is consistent with an arrangement direction of the plurality of scan lines 20. The substrate 10 comprises an active display area 11 and a peripheral area 12 outside the active display area 11. The plurality of scan lines 20 comprises a plurality of first scan lines 21 located in the active display area 11 and a plurality of second scan lines 22 between an area where the plurality of first scan lines 21 are located and an edge of the end of the substrate 10 having the notch 15. Each of the second scan lines 22 comprises a first sub-scan line 221 and two second sub-scan lines 222 respectively connected to two ends of the first sub-scan line 221. The first sub-scan line 221 of each second scan line 22 corresponds to the notch 15 and is located in the peripheral area 12, and the two second sub-scan lines 222 of each second scan line 22 are respectively located on two sides of the notch 15 and are located in the active display area 11. The capacitance compensation module 30 corresponds to the notch 15 and is located in the peripheral area 12. The capacitance compensation module 30 comprises a plurality of semiconductor blocks 31 disposed in an array and between the substrate 10 and the plurality of first sub-scan lines 221, and insulated from the plurality of first sub-scan lines 221, and a plurality of compensation traces 32 between the plurality of semiconductor blocks 31 and the plurality of first sub-scan lines 221, and insulated from the plurality of semiconductor blocks 31 and the plurality of first sub-scan lines 221. Each row of semiconductor blocks 31 is correspondingly located below one first sub-scan line 221. Each compensation trace 32 is correspondingly located above a column of semiconductor blocks 31 and intersects with the plurality of first sub-scan lines 221. Each first sub-scan line 221 is connected to a row of semiconductor blocks 31 corresponding thereto via through holes 33. The plurality of compensation traces 32 are connected to a preset reference potential. In any two first sub-scan lines 221, a capacitance between the first sub-scan line 221 away from the notch 15, the corresponding semiconductor block 31 and the compensation trace 32 below the first sub-scan line 221 is smaller than a capacitance between the first sub-scan line 221 close to the notch 15, the corresponding semiconductor block 31 and the compensation trace 32 below the first sub-scan line 221. The plurality of rows of sub-pixels 40 is located in the active display area 11. The plurality of sub-pixels 40 corresponding to the second scan lines 22 are respectively connected to the two second sub-scan lines 222 of the second scan line 22, and are respectively located at two sides of the notch 15.

Specifically, the preset reference potential may be a constant voltage low potential or a common potential.

Specifically, the plurality of second sub-scan lines 222, the plurality of first scan line 21 and the plurality of compensation traces 32 are located in the same layer.

Specifically, referring to FIG. 4, a distance between two side walls of the notch 15 gradually decreases in a direction close to the center of the substrate 10.

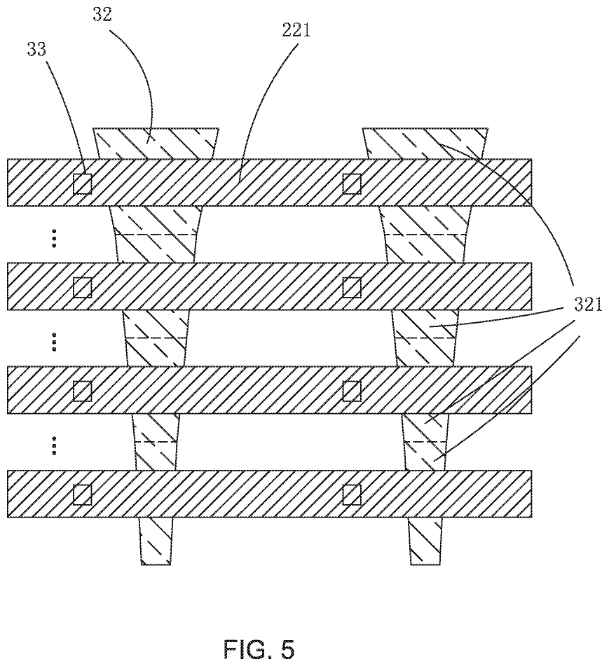

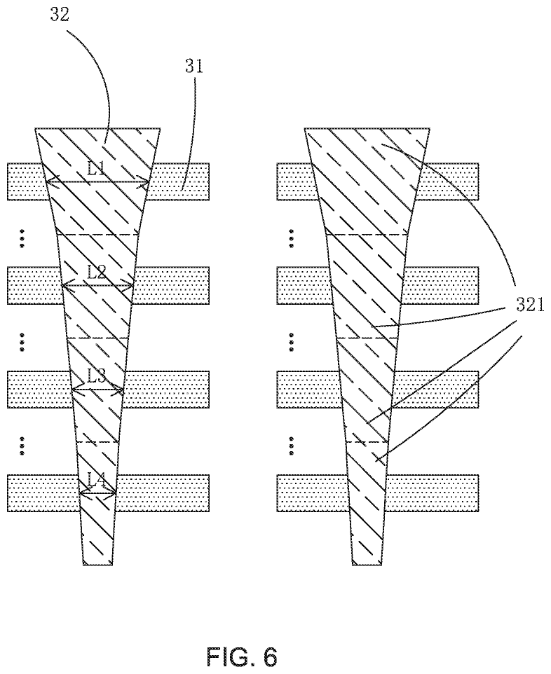

Specifically, referring to FIG. 5 and FIG. 6, in the first embodiment of the present invention, in any two first sub-scan lines 221, a width of an overlapped area between the first sub-scan line 221 away from the notch 15, the corresponding semiconductor block 31 and the compensation trace 32 below the first sub-scan line 221 is smaller than a width of an overlapped area between the first sub-scan line 221 close to the notch 15, the corresponding semiconductor block 31 and the compensation trace 32 below the first sub-scan line 221.

Furthermore, referring to FIG. 5 and FIG. 6, in the first embodiment of the present invention, each of the compensation traces 32 comprises four trapezoidal portions 321 connected in sequence. Adjacent two trapezoidal portions 321 are connected to each other by respective bottom edges, and lengths of the bottom edges of the adjacent two trapezoidal portions 321 are equal.

Specifically, referring to FIG. 5 and FIG. 6, the plurality of semiconductor blocks 31 are the same in size and rectangular in shape. The plurality of compensation traces 32 are the same in size. Portions of the plurality of first sub-scan lines 221 located above an area of the capacitance compensation module 30 are parallel to each other and have a same width. Portions of any two adjacent first sub-scan lines 221 located above the area of the capacitance compensation module 30 have a same interval. A center line of the semiconductor blocks 31 of each row parallel to an arrangement direction is coincident with a center line of portions of the corresponding first sub-scan lines 221 located above the area of the capacitance compensation module 30. The plurality of compensation traces 32 are perpendicular to the portions of the plurality of first sub-scan lines 221 located above the area of the capacitance compensation module 30. A size of the semiconductor block 31 in a row direction of the plurality of semiconductor blocks 31 is greater than a width of the compensation trace 32.

Specifically, in the first embodiment of the present invention, the sizes of the four trapezoidal portions 321 of the plurality of compensation traces 32 are designed by simulation. The specific simulation process includes the following steps:

Step S1, selecting two of the plurality of second scan lines 22 except one closest to the notch 15 and one farthest from the notch 15 to be defined as a first reference scan line and a second reference scan line, respectively, wherein an interval between a portion of the first sub-scan line 221 of the second scan line 22 closest to the notch 15 located above the area of the capacitance compensation module 30 and a portion of the first sub-scan line 221 of the first reference scan line located above the area of the capacitance compensation module 30 is equal to an interval between the portion of the first sub-scan line 221 of the first reference scan line located above the area of the capacitance compensation module 30 and a portion of the first sub-scan line 221 of the second reference scan line located above the area of the capacitance compensation module 30, and is equal to an interval between the portion of the first sub-scan line 221 of the second reference scan line located above the area of the capacitance compensation module 30 and a portion of the first sub-scan line 221 of the second scan line 22 farthest to the notch 15 located above the area of the capacitance compensation module 30.

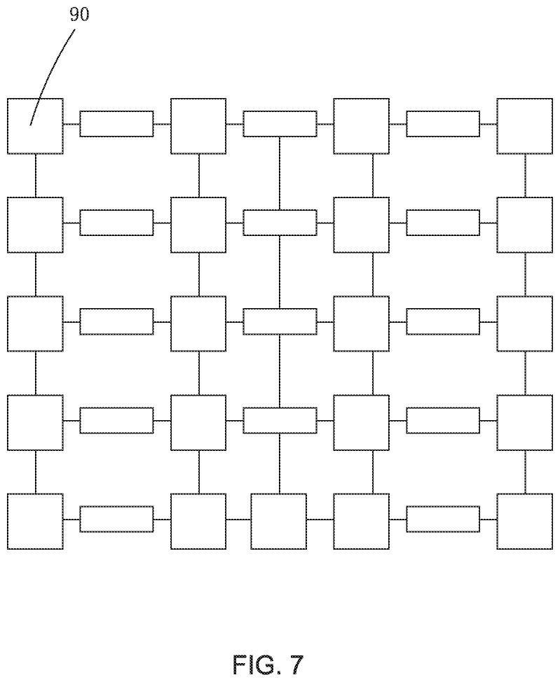

Step S2, referring to FIG. 7, providing a simulation system. The simulation system includes a plurality of simulation units 90 arranged in five rows and seven columns. Each row of simulation units 90 is electrically connected in sequence. The first column simulation unit 90 is electrically connected in sequence, and the third column simulation unit 90 is electrically connected in sequence, and the fourth column simulation unit 90 is electrically connected in sequence, and the fifth column simulation unit 90 is electrically connected in sequence, and the seventh column simulation unit 90 is electrically connected in sequence. The switching thin film transistor parameter, the liquid crystal capacitor parameter and the storage capacitor parameter of the sub-pixel 40 are stored in the simulation units 90 of the first row odd column, the second row odd column, the third row odd column, the fourth row odd column, the fifth row odd column and the fifth row fourth column. The products of the capacitance values and the resistance values of the simulation units 90 of the first row odd column, the second row odd column, the third row odd column, the fourth row odd column, the fifth row odd column and the fifth row fourth column are equal to the product of the capacitance value and the resistance value of the sub-pixel 40. Thus, the simulation units 90 of the first row of odd columns, the second row of odd columns, the third row of odd columns, the fourth row of odd columns, the fifth row of odd columns and the fifth row of fourth columns serves as pixel simulation units. The products of the capacitance values and the resistance values of the simulation units 90 of the first row second column and the first row sixth column are respectively equal to the products of the capacitance values and the resistance values of the two second sub-scan lines 222 of the second scan line 22 closest to the notch 15. The products of the capacitance values and the resistance values of the simulation units 90 of the second row second column and the second row sixth column are respectively equal to the products of the capacitance values and the resistance values of the two second sub-scan lines 222 of the first reference scan line. The products of the capacitance values and the resistance values of the simulation units 90 of the third row second column and the third row sixth column are respectively equal to the products of the capacitance values and the resistance values of the two second sub-scan lines 222 of the second reference scan line. The products of the capacitance values and the resistance values of the simulation units 90 of the fourth row second column and the fourth row sixth column are respectively equal to the products of the capacitance values and the resistance values of the two second sub-scan lines 222 of the second scan line 22 farthest to the notch 15. The products of the capacitance values and the resistance values of the simulation units 90 of the fifth row second column and the fifth row sixth column are both equal to one-half the product of the resistance value and the capacitance value of the first scan line 22. Then, the product of the capacitance value and the resistance value of the simulation unit 90 of the first row fourth column is equal to the product of the capacitance value and the resistance value of the first sub-scan line 221 of the second scan line 22 closest to the notch 15. Then, the product of the capacitance value and the resistance value of the simulation unit 90 of the second row fourth column is equal to the product of the capacitance value and the resistance value of the first sub-scan line 221 of the first reference scan line. Then, the product of the capacitance value and the resistance value of the simulation unit 90 of the third row fourth column is equal to the product of the capacitance value and the resistance value of the first sub-scan line 221 of the second reference scan line. Then, the product of the capacitance value and the resistance value of the simulation unit 90 of the fourth row fourth column is equal to the product of the capacitance value and the resistance value of the first sub-scan line 221 of the second scan line 22 farthest to the notch 15.

Step S3, inputting data signals to the simulation units 90 of the first column, the third column, the fourth column, the fifth column and the seventh column, respectively, and inputting scan signals to the simulation units 90 of the first row, the second row, the third row, the fourth row and the fifth row, wherein since each simulation unit 90 has a product of a capacitance value and a resistance value corresponding thereto, there are differences in the scan signals actually received by the simulation units 90 of the first column first row, the seventh column first row, the first column second row, the seventh column second row, the first column third row, the seventh column third row, the first column fourth row, the seventh column fourth row, the first column fifth row and the seventh column fifth row, and the simulation units 90 of the first column first row, the seventh column first row, the first column second row, the seventh column second row, the first column third row, the seventh column third row, the first column fourth row, the seventh column fourth row, the first column fifth row and the seventh column fifth row generate respective optimal common voltages according to the respective received scan signals, data signals, and the respective stored switching thin film transistor parameters, liquid crystal capacitance parameters and storage capacitance parameters of the sub-pixels 30. An average of the optimal common voltage generated by the simulation unit 90 of the first column first row and the optimum common voltage generated by the simulation unit 90 of the seventh column first row is defined as the first optimal common voltage. An average of the optimal common voltage generated by the simulation unit 90 of the first column second row and the optimum common voltage generated by the simulation unit 90 of the seventh column second row is defined as the second optimal common voltage. An average of the optimal common voltage generated by the simulation unit 90 of the first column third row and the optimum common voltage generated by the simulation unit 90 of the seventh column third row is defined as the third optimal common voltage. An average of the optimal common voltage generated by the simulation unit 90 of the first column fourth row and the optimum common voltage generated by the simulation unit 90 of the seventh column fourth row is defined as the fourth optimal common voltage. An average of the optimal common voltage generated by the simulation unit 90 of the first column fifth row and the optimum common voltage generated by the simulation unit 90 of the seventh column fifth row is defined as the fifth optimal common voltage.

Step S4, maintaining inputting the data signals to the simulation units 90 of the first column, the third column, the fourth column, the fifth column and the seventh column, respectively, and maintaining inputting the scan signals to the simulation units 90 of the first row, the second row, the third row, the fourth row and the fifth row, and increasing the capacitance values of the simulation unit 90 of the first row fourth column, the simulation unit 90 of the second row fourth column, the simulation unit 90 of the third row fourth column and the simulation unit 90 of the fourth row fourth column, such that the products of capacitance values and resistance values of the simulation unit 90 of the first row fourth column, the simulation unit 90 of the second row fourth column, the simulation unit 90 of the third row fourth column and the simulation unit 90 of the fourth row fourth column increase. Thus, the capacitance and resistance delays which can be generated by the simulation unit 90 of the first row fourth column, the simulation unit 90 of the second row fourth column, the simulation unit 90 of the third row fourth column and the simulation unit 90 of the fourth row fourth column become larger, and thus the scan signals actually received by the simulation units 90 of the first column first row, the seventh column first row, the first column second row, the seventh column second row, the first column third row, the seventh column third row, the first column fourth row and the seventh column fourth row change. The first optimal common voltage, the second optimal common voltage, the third optimal common voltage and the fourth optimal common voltage can be adjusted until the difference between the fifth optimal common voltage and the adjusted fourth optimal common voltage, the difference between the adjusted fourth optimal common voltage and the adjusted third optimal common voltage, and the difference between the adjusted third the optimal common voltage and the adjusted second optimal common voltage and the difference between the adjusted second optimal common voltage and the adjusted first optimal common voltage are all less than or equal to a preset standard deviation value (for instance, the value can be 2 mV). The first optimal width L1 of an overlapping portion of the plurality of compensation traces 32 and the first sub-scan line 221 of the second scan line 22 closest to the notch 15, the corresponding semiconductor block 31 is calculated according to the capacitance value of the simulation unit 90 of the first row fourth column and the capacitance value of the first sub-scan line 221 of the second scan line 22 closest to the notch 15. The second optimal width L2 of an overlapping portion of the plurality of compensation traces 32 and the first sub-scan line 221 of the first reference scan line, the corresponding semiconductor block 31 is calculated according to the capacitance value of the simulation unit 90 of the second row fourth column and the capacitance value of the first sub-scan line 221 of the first reference scan line. The third optimal width L3 of an overlapping portion of the plurality of compensation traces 32 and the first sub-scan line 221 of the second reference scan line, the corresponding semiconductor block 31 is calculated according to the capacitance value of the simulation unit 90 of the third row fourth column and the capacitance value of the first sub-scan line 221 of the second reference scan line. The fourth optimal width L4 of an overlapping portion of the plurality of compensation traces 32 and the first sub-scan line 221 of the second scan line 22 farthest to the notch 15, the corresponding semiconductor block 31 is calculated according to the capacitance value of the simulation unit 90 of the fourth row fourth column and the capacitance value of the first sub-scan line 221 of the second scan line 22 farthest to the notch 15.

Step S5, designing the size of the four trapezoidal portions 321 of the compensation traces 32 according to the first optimum width L1, the second optimum width L2, the third optimum width L3 and the fourth optimum width L4, such that the four trapezoidal portions 321 respectively have areas having widths of the first optimum width L1, the second optimum width L2, the third optimum width L3 and the fourth optimum width L4, wherein in the trapezoidal portions 321 having the area of the first optimum width L1, the area having the width of the first optimum width L1 is located between the first sub-scan line 221 of the second scan line 22 closest to the notch 15 and the corresponding semiconductor block 31, and in the trapezoidal portions 321 having the area of the second optimum width L2, the area having the width of the second optimum width L2 is located between the first sub-scan line 221 of the first reference scan line and the corresponding semiconductor block 31, and in the trapezoidal portions 321 having the area of the third optimum width L3, the area having the width of the third optimum width L3 is located between the first sub-scan line 221 of the second reference scan line and the corresponding semiconductor block 31, and in the trapezoidal portions 321 having the area of the fourth optimum width L4, the area having the width of the fourth optimum width L4 is located between the first sub-scan line 221 of the second scan line 22 farthest to the notch 15 and the corresponding semiconductor block 31.

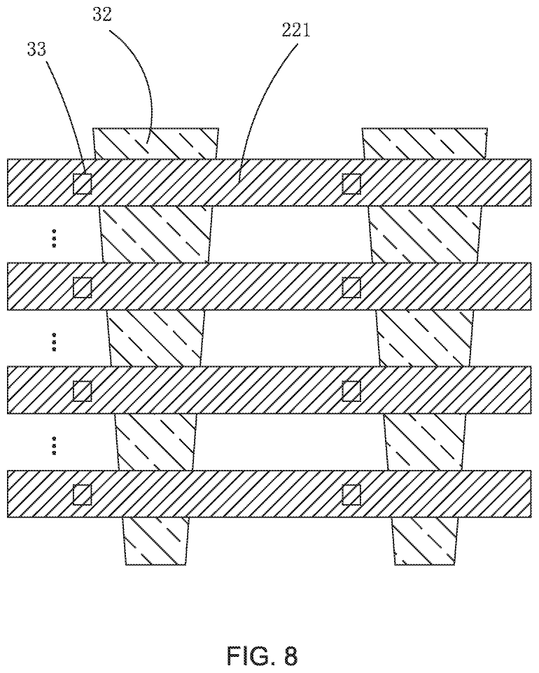

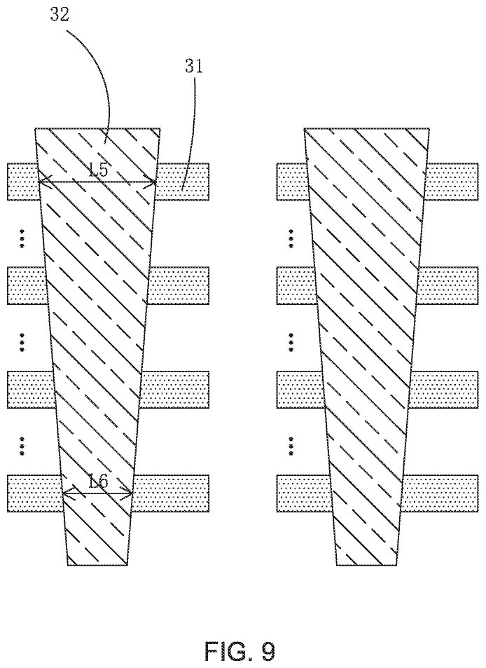

Referring to FIG. 4, FIG. 8 and FIG. 9, the second embodiment of the liquid crystal display panel of the present invention is different from the aforesaid first embodiment in that each compensation trace 32 has a trapezoidal shape.

Accordingly, in the second embodiment of the present invention, the specific simulation process of designing the sizes of the plurality of compensation traces 32 includes the following steps:

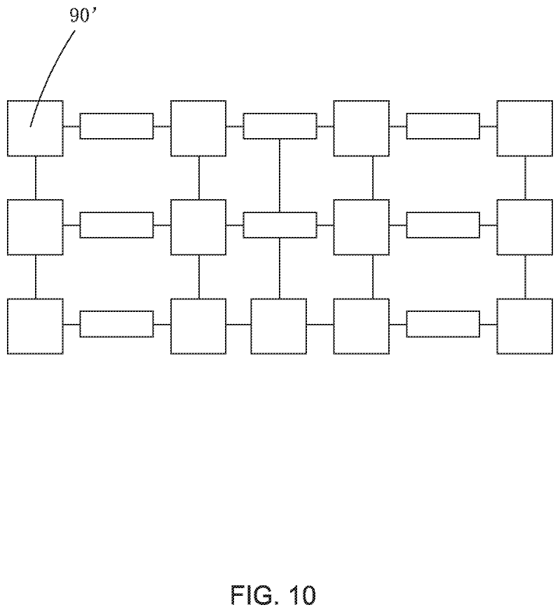

Step S1′, referring to FIG. 10, providing a simulation system. The simulation system includes a plurality of simulation units 90′ arranged in three rows and seven columns. Each row of simulation units 90′ is electrically connected in sequence. The first column simulation unit 90′ is electrically connected in sequence, and the third column simulation unit 90′ is electrically connected in sequence, and the fourth column simulation unit 90′ is electrically connected in sequence, and the fifth column simulation unit 90′ is electrically connected in sequence, and the seventh column simulation unit 90′ is electrically connected in sequence. The switching thin film transistor parameter, the liquid crystal capacitor parameter and the storage capacitor parameter of the sub-pixel 40 are stored in the simulation units 90′ of the first row odd column, the second row odd column, the third row odd column and the third row fourth column. The products of the capacitance values and the resistance values of the simulation units 90′ of the first row odd column, the second row odd column, the third row odd column and the third row fourth column are equal to the product of the capacitance value and the resistance value of the sub-pixel 40. Thus, the simulation units 90′ of the first row odd column, the second row odd column, the third row odd column and the third row fourth column serves as pixel simulation units. The products of the capacitance values and the resistance values of the simulation units 90′ of the first row second column and the first row sixth column are respectively equal to the products of the capacitance values and the resistance values of the two second sub-scan lines 222 of the second scan line 22 closest to the notch 15. The products of the capacitance values and the resistance values of the simulation units 90′ of the second row second column and the second row sixth column are respectively equal to the products of the capacitance values and the resistance values of the two second sub-scan lines 222 of the second scan line 222 farthest to the notch 15. The products of the capacitance values and the resistance values of the simulation units 90′ of the third row second column and the third row sixth column are both equal to one-half the product of the resistance value and the capacitance value of the first scan line 22. Then, the product of the capacitance value and the resistance value of the simulation unit 90′ of the first row fourth column is equal to the product of the capacitance value and the resistance value of the first sub-scan line 221 of the second scan line 22 closest to the notch 15. Then, the product of the capacitance value and the resistance value of the simulation unit 90′ of the second row fourth column is equal to the product of the capacitance value and the resistance value of the first sub-scan line 221 of the second scan line 22 farthest to the notch 15.

Step S2′, inputting data signals to the simulation units 90′ of the first column, the third column, the fourth column, the fifth column and the seventh column, respectively, and inputting scan signals to the simulation units 90′ of the first row, the second row and the third row, wherein since each simulation unit 90′ has a product of a capacitance value and a resistance value corresponding thereto, there are differences in the scan signals actually received by the simulation units 90′ of the first column first row, the seventh column first row, the first column second row, the seventh column second row, the first column third row and the seventh column third row, and the simulation units 90′ of the first column first row, the seventh column first row, the first column second row, the seventh column second row, the first column third row and the seventh column third row generate respective optimal common voltages according to the respective received scan signals, data signals, and the respective stored switching thin film transistor parameters, liquid crystal capacitance parameters and storage capacitance parameters of the sub-pixels 30. An average of the optimal common voltage generated by the simulation unit 90′ of the first column first row and the optimum common voltage generated by the simulation unit 90′ of the seventh column first row is defined as the sixth optimal common voltage. An average of the optimal common voltage generated by the simulation unit 90′ of the first column second row and the optimum common voltage generated by the simulation unit 90′ of the seventh column second row is defined as the seventh optimal common voltage. An average of the optimal common voltage generated by the simulation unit 90′ of the first column third row and the optimum common voltage generated by the simulation unit 90′ of the seventh column third row is defined as the eighth optimal common voltage.

Step S3′, maintaining inputting the data signals to the simulation units 90′ of the first column, the third column, the fourth column, the fifth column and the seventh column, respectively, and maintaining inputting the scan signals to the simulation units 90′ of the first row, the second row and the third row, and increasing the capacitance values of the simulation unit 90′ of the first row fourth column and the simulation unit 90′ of the second row fourth column, such that the products of capacitance values and resistance values of the simulation unit 90′ of the first row fourth column and the simulation unit 90′ of the second row fourth column increase. Thus, the capacitance and resistance delays which can be generated by the simulation unit 90′ of the first row fourth column and the simulation unit 90′ of the second row fourth column become larger, and thus the scan signals actually received by the simulation units 90′ of the first column first row, the seventh column first row, the first column second row and the seventh column second row change. The sixth optimal common voltage and the seventh optimal common voltage can be adjusted until the difference between the eighth optimal common voltage and the adjusted seventh optimal common voltage and the difference between the adjusted seventh optimal common voltage and the adjusted sixth optimal common voltage are both less than or equal to a preset standard deviation value (for instance, the value can be 2 mV). The fifth optimal width L5 of an overlapping portion of the plurality of compensation traces 32 and the first sub-scan line 221 of the second scan line 22 closest to the notch 15 is calculated according to the capacitance value of the simulation unit 90′ of the first row fourth column and the capacitance value of the first sub-scan line 221 of the second scan line 22 closest to the notch 15. The sixth optimal width L6 of an overlapping portion of the plurality of compensation traces 32 and the first sub-scan line 221 of the second scan line 22 farthest to the notch 15 is calculated according to the capacitance value of the simulation unit 90′ of the second row fourth column and the capacitance value of the first sub-scan line 221 of the second scan line 22 farthest to the notch 15.

Step S4′, designing the size of the compensation traces 32 according to the fifth optimum width L5 and the sixth optimum width L6, such that the compensation traces 32 have areas having widths of the fifth optimum width L5 and the sixth optimum width L6, wherein the area of the compensation traces 32 having the width of the fifth optimum width L5 is located between the first sub-scan line 221 of the second scan line 22 closest to the notch 15 and the corresponding semiconductor block 31, and the area of the compensation traces 32 having the width of the sixth optimum width L6 is located between the first sub-scan line 221 of the second scan line 22 farthest to the notch 15 and the corresponding semiconductor block 31.

Specifically, due to the notch design of the liquid crystal display panel of the present invention, the RC loadings of the first scan line 21 and the second scan line 22 are different, and the difference of the RC loadings of the plurality of first scan lines 21 also exists. The capacitance compensation module 30 corresponding to the notch 15 of the substrate 10 and located in the peripheral area 12 is disposed on the substrate 10. The capacitance compensation module 30 includes the plurality of semiconductor blocks 31 and the plurality of compensation traces 32. Each row of semiconductor blocks 31 is correspondingly located below one first sub-scan line 221. Each compensation trace 32 is correspondingly located above one column of semiconductor blocks 31 and intersects with the plurality of first sub-scan lines 221. Each first sub-scan line 221 is connected to one row of semiconductor blocks 31 corresponding thereto via through holes. Therefore, a capacitance is formed between each of the first sub-scan lines 221, the corresponding semiconductor blocks 31 and the compensation trace 32 to compensate the difference in RC loadings of the first scan line 21 and the second scan line 22. Meanwhile, in any two first sub-scan lines 221, a capacitance between the first sub-scan line 221 away from the notch 15, the corresponding semiconductor block 31 and the compensation trace 32 below the first sub-scan line 221 is smaller than a capacitance between the first sub-scan line 221 close to the notch 15, the corresponding semiconductor block 31 and the compensation trace 32 below the first sub-scan line 221. Specifically, in any two first sub-scan lines 221, a width of an overlapped area between the first sub-scan line 221 away from the notch 15, the corresponding semiconductor block 31 and the compensation trace 32 below the first sub-scan line 221 is smaller than a width of an overlapped area between the first sub-scan line 221 close to the notch 15, the corresponding semiconductor block 31 and the compensation trace 32 below the first sub-scan line 221. Therefore, the difference in RC loadings of the plurality of second scan lines 22 is reduced, thereby eliminating the brightness difference and the split-screen phenomenon caused by the difference in the RC loading delay of scan lines to improve the display effect of the liquid crystal display panel.

In conclusion, the liquid crystal display panel of the invention adopts a notch design. The capacitance compensation module corresponding to the notch of the substrate and located in the peripheral area is disposed on the substrate. The capacitance compensation module includes the plurality of semiconductor blocks and the plurality of compensation traces. Each row of semiconductor blocks is correspondingly located below one first sub-scan line. Each compensation trace is correspondingly located above one column of semiconductor blocks and intersects with the plurality of first sub-scan lines. Each first sub-scan line is connected to one row of semiconductor blocks corresponding thereto via through holes. In any two first sub-scan lines, a capacitance between the first sub-scan line away from the notch, the corresponding semiconductor block and the compensation trace below the first sub-scan line is smaller than a capacitance between the first sub-scan line close to the notch, the corresponding semiconductor block and the compensation trace below the first sub-scan line. Thus, the difference in RC loadings among the plurality of scan lines is compensated to improve the display effect.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A liquid crystal display panel, comprising a substrate, a plurality of scan lines sequentially arranged on the substrate and a capacitance compensation module disposed on the substrate;
wherein one end of the substrate is provided with a notch, of which a concave direction is consistent with an arrangement direction of the plurality of scan lines; the substrate comprises an active display area and a peripheral area outside the active display area; the plurality of scan lines comprises a plurality of first scan lines located in the active display area and a plurality of second scan lines between an area where the plurality of first scan lines are located and an edge of the end of the substrate having the notch; each of the second scan lines comprises a first sub-scan line and two second sub-scan lines respectively connected to two ends of the first sub-scan line; the first sub-scan line of each second scan line corresponds to the notch and is located in the peripheral area, and the two second sub-scan lines of each second scan line are respectively located on two sides of the notch and are located in the active display area; the capacitance compensation module corresponds to the notch and is located in the peripheral area; the capacitance compensation module comprises a plurality of semiconductor blocks disposed in an array and between the substrate and the plurality of first sub-scan lines, and insulated from the plurality of first sub-scan lines, and a plurality of compensation traces between the plurality of semiconductor blocks and the plurality of first sub-scan lines, and insulated from the plurality of semiconductor blocks and the plurality of first sub-scan lines; each row of semiconductor blocks is correspondingly located below one first sub-scan line; each compensation trace is correspondingly located above a column of semiconductor blocks and intersects with the plurality of first sub-scan lines; each first sub-scan line is connected to a row of semiconductor blocks corresponding thereto via through holes; the plurality of compensation traces are connected to a preset reference potential; in any two first sub-scan lines, a capacitance between the first sub-scan line away from the notch, the corresponding semiconductor block and the compensation trace below the first sub-scan line is smaller than a capacitance between the first sub-scan line close to the notch, the corresponding semiconductor block and the compensation trace below the first sub-scan line.

2. The liquid crystal display panel according to claim 1, wherein in any two first sub-scan lines, a width of an overlapped area between the first sub-scan line away from the notch, the corresponding semiconductor block and the compensation trace below the first sub-scan line is smaller than a width of an overlapped area between the first sub-scan line close to the notch, the corresponding semiconductor block and the compensation trace below the first sub-scan line.

3. The liquid crystal display panel according to claim 2, wherein each of the compensation traces comprises four trapezoidal portions connected in sequence; adjacent two trapezoidal portions are connected to each other by respective bottom edges, and lengths of the bottom edges of the adjacent two trapezoidal portions are equal.

4. The liquid crystal display panel according to claim 2, wherein each compensation trace has a trapezoidal shape.

5. The liquid crystal display panel according to claim 1, wherein the plurality of semiconductor blocks are the same in size and rectangular in shape; the plurality of compensation traces are the same in size; portions of the plurality of first sub-scan lines located above an area of the capacitance compensation module are parallel to each other and have a same width; portions of any two adjacent first sub-scan lines located above the area of the capacitance compensation module have a same interval; a center line of the semiconductor blocks of each row parallel to an arrangement direction is coincident with a center line of portions of the corresponding first sub-scan lines located above the area of the capacitance compensation module; a size of the semiconductor block in a row direction of the plurality of semiconductor blocks is greater than a width of the compensation trace.

6. The liquid crystal display panel according to claim 5, wherein the plurality of compensation traces is perpendicular to the portions of the plurality of first sub-scan lines located above the area of the capacitance compensation module.

7. The liquid crystal display panel according to claim 1, further comprising a plurality of rows of sub-pixels disposed on the substrate and correspondingly connected to the plurality of scan lines; wherein the plurality of rows of sub-pixels are located in the active display area; and the plurality of sub-pixels corresponding to the second scan lines are respectively connected to the two second sub-scan lines of the second scan line, and are respectively located at two sides of the notch.

8. The liquid crystal display panel according to claim 1, wherein the preset reference potential is a constant voltage low potential or a common potential.

9. The liquid crystal display panel according to claim 1, wherein the plurality of second sub-scan lines, the plurality of first scan line and the plurality of compensation traces are located in the same layer.

10. The liquid crystal display panel according to claim 1, wherein a distance between two side walls of the notch gradually decreases in a direction close to the center of the substrate.
